(19) United States
(12) Patent Application Publication
(10) Pub. No.: US 2014/0214816 A1
(43) Pub. Date: Jul. 31, 2014

(54) SYSTEM AND METHOD OF RELATIONSHIP DATASTORE MANAGEMENT

(71) Applicant: 2306748 ONTARIO INC., Toronto (CA)

(72) Inventors: Paul L.C. CHEN, Toronto (CA); Christopher Lawrence TRUDEAU, Toronto (CA)

(73) Assignee: 2306748 ONTARIO INC., Toronto (CA)

(21) Appl. No.: 13/827,841

(22) Filed: Mar. 14, 2013

Related U.S. Application Data
(60) Provisional application No. 61/756,839, filed on Jan. 25, 2013.

(51) Int. Cl. G06F 17/30

(52) U.S. Cl. CPC G06F 17/3053
USPC 707/723; 707/780

(57) ABSTRACT

A system and method of discovering provider contact data is provided. Provider connectivity data can be built and maintained in a data-store. Once a query is received for identifying a provider contact's data, connectivity data for the querying data is also built. Then the provider connectivity data is searched on the basis of the seeker connectivity data. One or more provider contacts are identified based on query criteria. The provider connectivity data includes a first level provider association data and a first level provider relations data. The seeker connectivity data includes a first level seeker association data and a first level seeker relations data. The connectivity data can be obtained from a variety of sources including contacts databases and third party service providers. Third party service providers include social networks and information aggregators.

This application is related to and claims priority to U.S. application entitled System and Method of Relationship Database management having Ser. No. 61/756839, filed on 25/Jan./2013 and incorporated by reference herein.

### BACKGROUND OF THE INVENTION

1. Field of the Invention

The present invention is directed to data-store management and processing in general and relationship based data maintenance and searching specifically.

2. Description of the Related Art

Discovering contacts with specific criteria, such as a plumber or a lawyer, typically involves using a web search engine, or searching databases of services such as directories and review sites that aggregate information regarding service and goods providers based on data submitted by the service providers as well as those that have interacted with these providers in the form of reviews and endorsements. Information discovered on the basis of these types of data entry is unreliable. The data provided by the service provider may be inaccurate or deliberately distorted. Moreover, information discovered in this manner may not be as reliable as that which can be discovered through social references to identify information that is appropriate to the seeker. Accordingly, a more reliable method of information discovery is needed.

### SUMMARY OF THE INVENTION

It is an aspect of the present invention to provide a method for a computing device, of contact discovery. The method can comprise:

building a provider connectivity data;

receiving a query for a contact;

building a seeker connectivity data; and

searching said provider connectivity data based on said seeker connectivity data.

The provider connectivity data can include a first level provider association data and a first level provider relations data. The seeker connectivity data can include a first level seeker association data and a first level seeker relations data. The provider connectivity data can be obtained from at least one of a contacts database and a third party service provider. The third party service provider can be one or more of a social networking service, a web hosting service, a directory service and an aggregator service.

The method can further comprise identifying, based on the searching, a result including at least one of a provider contact data and an association chain. The provider connectivity data and the seeker connectivity data can include metadata. The method can further comprise prioritizing the result based on metadata. The metadata can include at least one of relationship strength indicator, endorsement, service volume and reviews. The identifying of the result can be based on matching the first level provider relation data with the first level seeker relation data. The matching can be based on a geographic relationship. The geographic relationship can be based on proximity.

The method can further comprise:

identifying, based on the searching, a relation data representing a relation; and

generating an incentive based on the identified relation data.

The method can further comprise obtaining authorization for building the provider connectivity data. The provider connectivity data can include a first and a second level provider relation data and the authorization can be obtained based on the first level provider relation data. The building of the provider connectivity data includes maintaining the provider connectivity data in a data-store. The identifying can based on a query criterion.

It is another aspect of the present invention to provide a system of contact discovery. The system can comprise a computing device configured for:

building a provider connectivity data;

receiving a query for a contact;

building a seeker connectivity data; and

searching the provider connectivity data based on the seeker connectivity data.

The computing device can be a server. The computing device can be further configured to obtain the provider connectivity data from at least one of a contacts database and a third party service provider.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 shows a block diagram of an embodiment of a system for relationship data management;

FIG. 2 shows a diagram of connectivity data in accordance with an embodiment;

FIG. 3 shows a flow chart showing a method of relationship data management in accordance with an embodiment;

FIG. 4 shows a diagram of connectivity data in accordance with an embodiment; and

FIG. 5 shows a diagram of connectivity data in accordance with an embodiment.

### DETAILED DESCRIPTION OF THE PREFERRED EMBODIMENTS

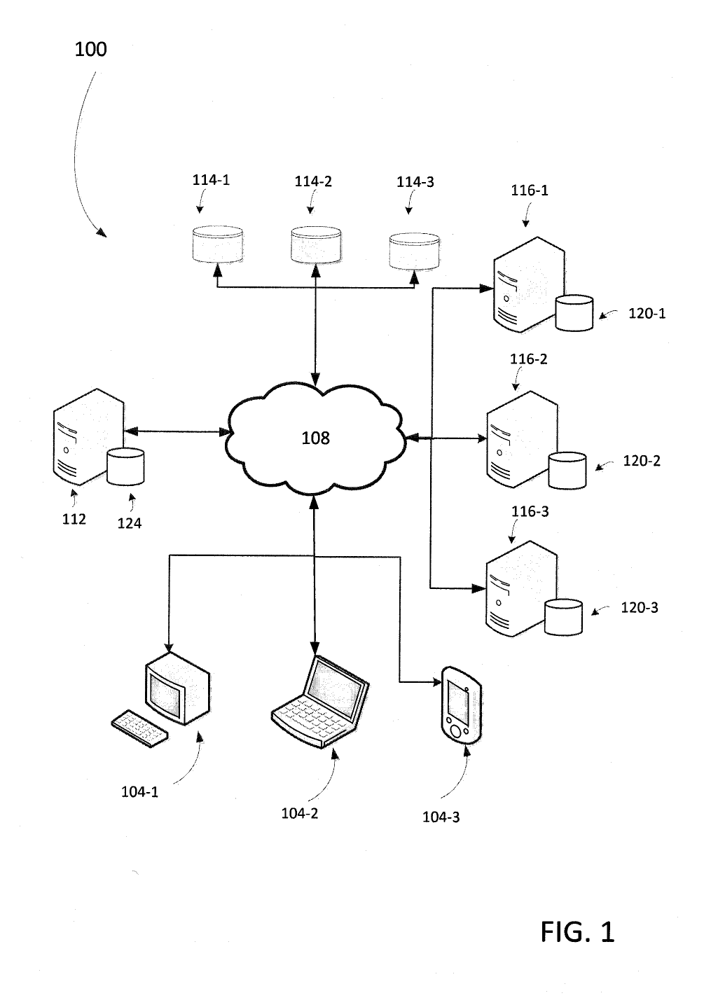

FIG. 1 shows a diagram of a system 100 for relationship database management. At least one client terminal (client terminals 104-1, 104-2 and 104-3) is connected, via network 108, to server 112. Collectively, client terminals 104-1, 104-2 and 104-3 are referred to as client terminals 104, and generically as client terminal 104. This nomenclature is used elsewhere herein. Additionally, server 112 can also access at least one third party server 116 (third party servers 116-1, 116-2 and 116-3) through network 108. Collectively, third party servers 116-1, 116-2 and 116-3 are referred to as third party servers 116, and generically as third party server 116. This nomenclature is used elsewhere herein. Discovery server 112, third party servers 116 and client terminals 104 can also access at least one cloud based storage 114 (cloud based storage 114-1, 114-2 and 114-3) through network 108. Collectively, cloud based storage 114-1, 114-2 and 114-3 are referred to as cloud based storage 114, and generically as cloud based storage 114. This nomenclature is used elsewhere herein.

Client terminals 104 can be based on any suitable computing environment, and the type is not particularly limited so long as each client terminal 104 is capable of receiving data from discovery server 112, displaying data and transmitting data to discovery server 112. In a present embodiment, client terminals 104 are configured to at least execute a web browser that can interact with the services hosted by discovery server 112. In other embodiments other applications can be hosted and executed by terminal 104 that can interact with discovery server 112.

Client terminals 104 can be based on any type of client computing environment, such as a desktop computer, a laptop computer, a netbook, a tablet, a smartphone, other mobile computing device or any other platform suitable for information processing that is known in the art. Each client terminal 104 includes at least one processor connected to a non-transitory computer readable storage medium such as a memory. Memory can be any suitable combination of volatile (e.g. Random Access Memory (“RAM”)) and non-volatile (e.g. read only memory (“ROM”), Electrically Erasable Programmable Read Only Memory (“EEPROM”), flash memory, magnetic computer storage device, or optical disc) memory. In one embodiment, memory includes both a non-volatile memory for persistent storage computer-readable instructions and other data, and a non-volatile memory for short-term storage of such computer-readable instructions and other data during the execution of the computer-readable instructions. Other types of computer readable storage medium external to client terminal 104 are also contemplated, such as secure digital (SD) cards and variants thereof. Other examples of external computer readable storage media include compact discs (CD-ROM, CD-RW) and digital video discs (DVD).

Client terminal 104 can also include one or more input devices connected to at least one processor. Such input devices are configured to receive input and provide data representative of such input to the processor. Input devices can include, for example, a keypad and a pointing device. A pointing device can be implemented as a computer mouse, track ball, track wheel, touchscreen or any suitable combination thereof. In some examples, client terminal 104 can include additional input devices in the form of one or more additional buttons, light sensors, microphones and the like. More generally, any suitable combination of the above-mentioned input devices can be incorporated into client terminal 104.

Client terminal 104 further includes one or more output devices. The output device s of client terminal 104 can include speakers, haptic feedback devices and others. The output devices of client terminal 104 can also include a display. When the pointing device includes a touchscreen, the touchscreen can be integrated with the display. Each client terminal 104 also includes a communications interface connected to the processor. The communications interface allows client terminal 104 to communicate with other computing devices, for example via network 108. The communications interface is therefore selected for compatibility with network 108.

Network 108 can comprise any network capable of linking discovery server 112 with client terminals 104 and can include any suitable combination of wired and/or wireless networks, including but not limited to a Wide Area Network (WAN) such as the Internet, a Local Area Network (LAN), cell phone networks, Wi-Fi networks, WiMax networks and the like.

In general terms, discovery server 112 can comprise any platform capable of processing, transmitting, receiving, and storing data. In a present embodiment, discovery server 112 is a server configured for data-store management and processing in general and for contact data discovery specifically. Discovery server 112 can be based on any desired server-type computing environment including appropriate configurations of one or more central processing units (CPUs) configured to control and interact with non-transitory computer readable media in the form of computer memory or a storage device. Computer memory or storage device can include volatile memory such as Random Access Memory (RAM), and non-volatile memory such as hard disk drives or FLASH drives, or a Redundant Array of Inexpensive Disks (RAID) or cloud-based storage 114. Discovery server 112 also includes one or more network interfaces, to connect to network 108 or client terminal 104. Discovery server 112 can also be configured to include input devices such as a keyboard or pointing device or output devices such as a monitor or a display or any of or all of them, to permit local interaction. Other types of hardware configurations for discovery server 112 are contemplated. For example, discovery server 112 can also be implemented as part of a cloud-based computing solution, whereby the functionality of discovery server 112 is implemented as one or more virtual machines executing at a single data center or in a mirrored form across a plurality of data centers. The software aspect of the computing environment of discovery server 112 can also include remote access capabilities in lieu of, or in addition to, any local input devices or local output devices. Any desired or suitable operating system can be used in the computing environment of discovery server 112. The computing environment can be accordingly configured with appropriate operating systems and applications to effect the functionality discussed herein. Those of skill in the art will now recognize that discovery server 112 need not necessarily be implemented as a stand-alone device and can be integrated as part of a multi-purpose server or implemented entirely in software, for example a virtual machine. In a present embodiment, discovery server 112 is connected to a storage device, such as a hard-disk drive, solid state drive, or any other type and arrangement of non-volatile storage device.

Continuing with FIG. 1, third party servers 116 are also shown. Third party servers 116 can comprise any platform capable of processing, transmitting, receiving, and storing data. In a present embodiment, third party servers 116 are configured to host third party services such as on-line stores, web sites, directory services or other information aggregation sites, social networking services, communications services and others. FIG. 1 shows third party server 116 to be linked to discovery server 112 through network 108, although other variations in connectivity, such as links through a network separate or different from 108 and connections through proxies and gateways is contemplated and are within scope.

In the present embodiment third party servers 116 include third party data-stores 120. Data stores 120 can be maintained on non-volatile memory such as hard disk drives or FLASH drives, or a Redundant Array of Inexpensive Disks (RAID) or cloud-based storage 114. Data-stores 120 are typically used for, in addition to other functionality, storing or maintaining contact data such as names, locations, types of contact such as individuals, groups, businesses and other organizations, occupation, type of business, service and others. Data-stores 120 can also include contact related data such as which contacts are associated, type of associations or relationships such as friends, colleagues and others, reviews of contacts by other contacts, endorsements such as likes or dislikes, and other relationship data associated with each contact. For example, in the case of social networks such as Facebook™ and LinkedIn™, a data-store 120 can include contact data as well as contact related data such as which contacts are related, the type of relationships between related contacts, contact reviews, endorsements, likes and others. In the case of social communications services such as Twitter or blog sites a data-store 120 can include contact data as well as contact related data such as which contacts follow which other contacts. In the case of web sites, directories and other third party services, data-store 120 can include contact data as well as contact related data such as contact reviews, endorsements and others. Third party servers 116 can generally perform the functions of obtaining contact data and contact related data. A third party server 116 can however access one or more other third party servers 116 or other computing devices, to access other third party services such as search sites and other information aggregators and others to perform one or more of its functions.

In the present embodiment, discovery server 112 maintains a relationship data-store 124. Relationship data-store 124 can be maintained on a storage device integral to or attached to discovery server 112, or can be maintained at a remote storage facility such as a network connected storage device of at cloud storage or a combination of these storage options can be used. Broadly speaking, relationship data-store 124 is any data-store containing connectivity data which represents connectivity of one or more provider contacts such as individuals, businesses or other service and goods providers. Connectivity data generally includes provider data representative of at least one provider contact. Included in data-store 12, connectivity data can be operated on for searching and otherwise processing. Searching or otherwise processing the connectivity data can allow the discovery of provider data maintained in data-store 124. As an example, provider data representing a provider contact can be included in data-store 124 containing contact information for a plumbing service provided by, for example, Alfonzo Plumbing which would like that information to be discoverable by potential customers searching for a plumber. Connectivity data for Alfonzo plumbing would also be configured to include multiple level relations of Alfonzo Plumbing including the customers, friends, friends of customers and other relations of the plumbing service provider. The provider data for Alfonzo Plumbing can accordingly be discovered by processing the connectivity data, namely by traversing or searching data representing the relations or associations of Alfonzo Plumbing. It will now be apparent to those of skill in the art that a contact can at once be a provider contact and a relation contact. For example, in a case where Alfonzo Plumbing is also a client of a wholesale supplier Plumbing Supplies, Alfonzo Plumbing can be both a provider contact as a provider of plumbing services, and a relation contact as a customer of Plumbing Supplies.

Connectivity data typically also include first-level associations representing relationships a provider contact can maintain with other contacts such as “client”, “friend”, “neighbor” and “reviewer”. Additionally, connectivity data can include metadata related to associations such as indicators of relationship strength or importance or other indicators of relationship quality such as an endorsement, closest friend, quantity of services provided and others that will now occur to a person of skill in the art. Connectivity data typically further includes first-level relation data indicative of contacts which have a direct relationship or relationships with a provider contact. For example, if the connectivity data includes a first-level relation data that is associated with a provider data through a “client” association, that connectivity data would be indicative that the first-level relation represented by that first-level relation data is a client of the service provider represented by that provider data.

Connectivity data can further include second-level associations representing direct relationships first-level relation contacts maintain with contacts other than the provider contact. The types of relationships and related meta-data such as indicators of relationship quality possible for second-level associations can be the same as first level associations. However, in variations these can differ. Connectivity data can further include second-level relation data indicative of contacts which have a direct relationship or relationships with first-level relation contacts. For example, if the connectivity data includes a second-level relation data that is associated with a first level relation data through a “friend” association, that connectivity data would be indicative that the second-level relation represented by that second-level relation data is a friend of the first level relation represented by that first level relation data. It will now be apparent to a person of skill in the art that the contacts associated with first-level relations through second level associations are not necessarily different from other first-level relations. Namely, in some embodiments, a first-level relation can have a second-level association with another first level relation. It will also now be apparent to a person of skill in the art that additional level associations, metadata and relations can be added to a connectivity data as required. Indeed, connectivity data can comprise of any level of associations and relations, in a manner that forms lists, trees, graphs or networks depending on the complexity of the connectivity data.

Data-store 124 and the connectivity data contained therein can be implemented using a variety of constructs including linked lists, arrays, object oriented containers, relational or flat databases, or recursive structures amongst others. Moreover, although in this embodiment, the connectivity data has been stored in a single data-store 124, in other variations, the data may be stored in more data-stores or other structures organized in a different manner. Variations in the implementation of data-store 124 and the connectivity data will now occur to one of skill in the art, all of which are contemplated as possible implementations of data storage and are considered within scope.

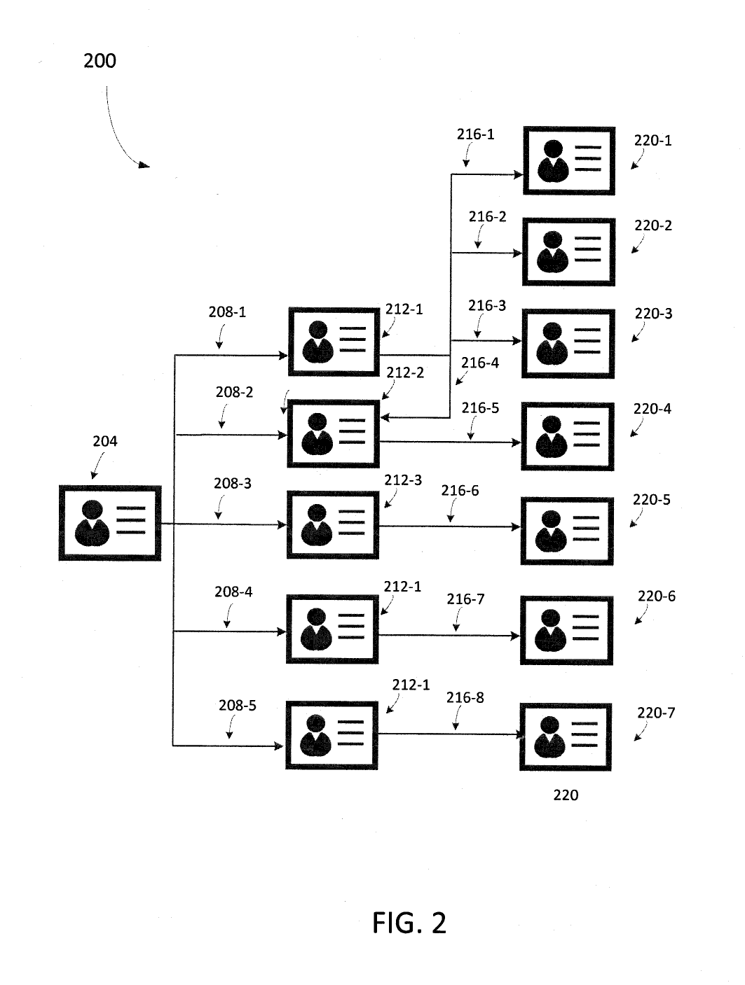

FIG. 2 shows a simplified representation of the kinds of connectivity data that can be stored at data-store 124 and operated upon by server 112 to perform data-store management and processing. As shown in FIG. 2, in this present embodiment, an example connectivity data indicated at 200 that is stored in data-store 124 in this example embodiment. It is to be understood that example connectivity data 200 is shown merely as an illustrative example and for the purposes of explaining various embodiments. Connectivity data with different content and organization will now occur to a person of skill in the art and is within scope.

Connectivity data 200 includes provider contact-data as indicated at 204. Provider contact-data can be data which is maintained in data-store 124 and is representative of a contact that provides goods or services or performs other functionality and would like to be discoverable through the data-store 124. Accordingly, provider contact-data 204 can include, for example, email, and other identifying information related to that contact. Additional information can also be included such as work hours, service and service type description, goods provided as well as additional contact information. Alternatively, less information can be included, such that the provider contact-data 204 includes, for example, just an email, or hash of an email. As an illustrative example, it'll be assumed that in this example embodiment, contact data 204 is for Alfonzo Plumbing, and includes an email, an address and a telephone number associated with the business.

Continuing with FIG. 2, in accordance with the indicated connectivity data 200, provider data 204 has first-level associations 208 (first level associations 208-1, 208-2, 208-3, 208-4 and 208-5). Collectively, first level relations data 208-1, 208-2, 208-3, 208-4 and 208-5 are referred to as first level associations 208, and generically as first level associations 208. This nomenclature is used elsewhere herein. First-level associations 208 are for associating provider data 204 with first-level relations data 212 (first level relations data 212-1, 212-2, 212-3, 212-4 and 212-5). Collectively, first level relations data 212-1, 212-2, 212-3, 212-4 and 212-5 are referred to as first level relations data 212, and generically as first level relations data 212. This nomenclature is used elsewhere herein. First-level associations 208 can be indicative of different types of relationships that a provider contact can have with others as well as the strength or importance of that relationship such as ratings, endorsements, and quantity of services provided. First-level relations data 212 can be contact-data indicative of relations with whom provider contact has established direct relationships. Continuing with the illustrative example, it'll be assumed that all associations 208 are of type “customer”, indicating that first level relations represented by first level relations data 212 are clients or customers of Alfonzo Plumbing. Moreover, it'll be assumed that first level relations data 212-1 is representative of a contact named “Emily”.

Continuing with FIG. 2, in accordance with the indicated connectivity data 200, provider data 204 has second-level associations 216 (second level associations 216-1, 216-2, 216-3, 216-4, 216-5, 216-6, 216-7 and 216-8). Collectively, second level relations data 216-1, 216-2, 216-3, 216-4, 216-5, 216-6, 216-7 and 216-8 are referred to as second level associations 216, and generically as second level associations 216. This nomenclature is used elsewhere herein. Second level associations 216 are for associating first-level relations data 212 with second level relations data 220 (second level relations data 220-1, 220-2, 220-3, 220-4, 220-5, 220-6 and 220-7). Collectively, second level relations data 220-1, 220-2, 220-3, 220-4, 220-5, 220-6 and 220-7 are referred to as second level relations data 220, and generically as second level relations data 220. This nomenclature is used elsewhere herein. Second-level associations 216 can be indicative of different types of relationships that a first-level relation can have with others. Second-level relations data 220 can be contact-data indicative of relations with which first-level relations has established direct relationships. Continuing with the present example embodiment, it'll be assumed that all second-level associations 216 are of type “friend”, indicating that first-level relations 212 are friends with second level relations. However, not all second-level associations might be with second-level relations. For example, as indicated in FIG. 2, first-level relation data 212-1 representing contact information for “Emily” has a second level association with another first-level relations data 212-2.

Connectivity data 200 can also include first level and second level metadata (not shown) indicative of the strength or importance of an association based on such metadata as ratings, endorsements, and quantity of services provided, for example.

It should now be understood that example connectivity data 200 shown in FIG. 2 is an illustrative example and that connectivity data 200 can take on greater complexity. For example, in an embodiment, relationship data-store 124 can include multiple provider data 204, more than one of which can be associated with, in some cases, the same first-level relations data 212. For example, different providers can have the same “customer”. In a further embodiment, a provider data 204 can have different associations 208 with different first-level relations data 212, such that, for example, provider data 204 can have one type of association 208, such as “friend”, with some first-level relations data 212, while other first-level relations data 212 can have, with provider data 204, different types of first-level association 208, such as “customer” or different relationship quality identifiers or both. In other variations, provider data 204 can have multiple first-level associations 208 with a first-level relation data 212 indicating that the provider contact represented by provider data 204 has, for example, both a friend and a service provider relationship with a relation contact indicated by a first-level relation data 212. Further, higher level associations, metadata and relations can also be included. A person of skill, in the art will now understand that similar variations are also possible for second-level associations and relationships, and are within scope.

Connectivity data 200 can be obtained in numerous ways. For example, in one embodiment, a provider can provide its contact information, representing first-level relations along with relationships that define the first level association with each of the provided contacts. The provided contact information can be obtained from a contacts database maintained at a terminal 104 or a server 116. The provided contacts can also be obtained from a web site operated by the provider contact. For example, continuing with the present example embodiment, Alfonzo Plumbing can obtain contact information manually and store it in a contacts database. Alfonzo Plumbing can also maintain a web site at the third party server 116-1 for the plumbing business. The clients of Alfonzo Plumbing can be given the ability to enter, at the web site, their contact information, as well as additional information such as review of services, pictures of the final product delivered, reviews, ratings of the service and others that will now occur to a person of skill in the art. All of this information can be maintained as part of the web site, or may be transferred to a data-store 120-1 or a contacts database for storage. Alternatively, parts or all of the information collected from the clients can be provided as part of the web pages of the web site and mined for use in data-store 124.

Connectivity data can also be obtained from one or more third party services, such as Facebook™, Google™, Twitter™ or LinkedIn™, and other networked data sources, including call center servers, directories, commerce servers, web services and other information service providers and aggregators. In one variation, discovery server 112 can obtain data from third party services by functioning as an aggregator, accessing the respective service's access points or APIs, having obtained appropriate permissions if necessary. Alternatively, discovery server 112 can obtain data from third party services and other networked sources by accessing third party aggregator services that aggregate information from the third party services as well as from other networked information sources. Discovery server 112 is typically linked to the third party service access points or aggregators, or a combination thereof, through network 108. Other methods of connecting to third party services and aggregators are contemplated such as through proxies and gateways are considered within scope.

Continuing with the example embodiment, provided contacts can be obtained from a third party data-store, such as Google™ Contacts maintained for the provider contact Alfonzo Plumbing. Alfonzo Plumbing can also maintain membership with third party services such as social networking sites. Accordingly, at least some of the provided contacts can be obtained from these services based on connections that Alfonzo Plumbing has made at those third party services. For example, Alfonzo plumbing can maintain a membership at the social networking site Facebook™, maintained by at least one of the third party servers 116 of FIG. 1, and the provided contacts can be those that “friended” or otherwise connected with Alfonzo Plumbing's Facebook™ membership. In other variations, Alfonzo plumbing may aggregate the provided contacts from third party services that aggregate information such as directory sites and news web sites that aggregate lists of service providers and collect client information such as reviews and ratings, maintained at least some of the third party servers 116. In yet further variations, provided contacts can be obtained through web search results provided by web search providers such as Google™ and Bing™. Searches can be conducted to identify clients that have posted reviews, ratings, project results and other information regarding Alfonzo Plumbing on their own sites, on sites maintained by others, blogs, social networking sites and others that will now occur to a person of skill in the art. Although in this example, the provided contacts are gathered by Alfonzo plumbing, in variations, discovery server 112 can perform the aggregation of provided contacts based on at least some of the method discussed.

Connectivity data 200 can also be provided by a relations contact. For example, a client contact can provide their contact info and relationship type to be added to an existing provider contact data's connectivity data, representing first level associations and relations for that provider data. Alternatively, where provider data 204 does not previously exist in data-store 124, a client can also provide the provider data 204 initiating the creation of the connectivity data for the provider contact. In some variations, client provided data is verified prior to entering into data-store 124. Continuing with the present example, a client “Elsa” of Alfonzo Plumbing can, based on prior interaction or a request from Alfonzo Plumbing for example, submit to relationship data-store 124, her contact info, which would form a first-level relation data 212-2 and their relationship, “client”, which would form a first-level association 208-2 associating “Elsa”'s relation data 212-2 with Alfonzo Plumbing's provider data 204.

In further variations, provided contacts may be obtained through dedicated applications maintained on a third party servers 116 or client terminals 104. Continuing with the illustrative example embodiment, Alfonzo Plumbing can provide a web based application or an application for execution on a client terminal 104 for use by its client “Elen”. Accordingly, “Elen”, through operation of the application at a client terminal 104, for example, can provide the necessary information for creating a first-level relation data 212-3 pertaining to her, as well as the type of relationship that will form the basis of the first level association 208-3 linking “Elen”'s relation data 212-3 to Alfonzo Plumbing's provider contact data 204.

Obtaining second level associations 216 and second level relations data 220 typically proceeds in a similar manner to obtaining first-level association 208 and relation data 212. However, in the case of the second-level relationship data, the data is obtained from a first-level relation rather than the provider. For example, in one embodiment, first-level relation 212-1, “Emily” can provide her contacts, representing second-level relations along with relationships that define the second-level association of “Emily” with each of the provided second-level relations. The provided second-level relations can be obtained from a contacts database maintained at a terminal 104 or a server 116. The provided second-level contacts can also be obtained from a web site.

Second-level connectivity data can also be obtained from one or more third party services, such as Facebook™, Google™, Twitter™ or LinkedIn™, and other networked data sources, including call center servers, directories, commerce servers, web services and other information service providers and aggregators. Continuing with the example embodiment, a first-level relation can maintain entries with third party services such as social networking sites and aggregate the provided contacts from these services. For example, “Emily” can maintain a membership at the social networking site Facebook™ maintained at one or more of the third party servers 116 of FIG. 1. Accordingly, second-level contacts provided can be those that “friended” or otherwise connected with “Emily”'s Facebook™ membership. In other variations, second-level relations data may be aggregated from third party services that aggregate information such as directory sites and news web sites that aggregate lists of relationships and collect client information such as reviews and ratings, maintained at one or more of the third party servers 116. In yet further variations, provided contacts can be obtained through web search results provided by web search providers such as Google™ and Bing™. Searches can be conducted to identify relations that have engaged “Emily” on their own sites, on sites maintained by others, blogs, social networking sites and others that will now occur to a person of skill in the art. Continuing with the example embodiment, it'll be assumed that second-level relation data 220-1 is for contact “Emma” whose information is provided by contact “Emily”.

Obtaining higher level data representing third fourth or higher level relations and associations would be similar to that of the second level data except that the data would be obtained through second or higher level relations.

In some circumstances, obtaining second-level (or higher) relationship data may need acknowledgement or otherwise approval of a first-level (or higher level) relation either when initially engaging that relation, or periodically after the initial engagement or both. For example, “Emily” may have to consent before her contacts can be mined from various sources to obtain second-level connectivity data. The approval can be obtained through a client terminal 104 operated by the contact “Emily”. The approval can be provided to third party services maintained at servers 116, which maintain the relation data for the second level (or higher) relation providing the relation information. For example, “Emily” can provide authorization, directly or indirectly, to access her friends through Facebook service.

To encourage a relation to provide consent for mining their contacts, various incentives can be provided to that relation by providing incentive information to that relation as identified by the relations data in data store 124. Continuing with the example embodiment, “Emily” can be provided with rewards, gifts cards, discounts from the provider she is directly or indirectly connected to or other providers maintained in data-store 124. These incentives and rewards can be based on the on the number of contacts provided by “Emily” or the size of higher-level relations derived from “Emily”'s contacts. The rewards or incentives can also be based on the number of contacts provided by “Emily” or derived from the contacts provided by “Emily” that are used in engaging the provider connected to “Emily”, or some other provider. Alternatively, to encourage “Emily” to continue to participate after initial engagement, notifications can be provided when one of her contacts or those derived from one of her contacts engage a provider in data-store 124, or are somehow utilized in engaging a provider.

In a further variation, the relations provided by “Emily” can also be incentivized. For example, “Emma”, as represented by second level relationship data 220-1 can receive discounts and other incentives based on the fact that her data was provided by “Emily” represented by the first level relation data 212-1. Furthermore, Emily can also be provided with information regarding the incentives provide to second level relations provide by her, by for example, providing text messages such as “your participation got your friend Emma a 10% discount!” or other messages to a client terminal 104 operated by her.

Variations in the implementation of system 100 will now occur to one of skill in the art, all of which are contemplated as possible implementations of system 100 and are considered within scope. For example, in some embodiments, only provider data 204 can be maintained in data-store 124, the remaining components of connectivity data being reconstructed each time the connectivity data needs to be searched, processed or utilized. As a further example, provider data 204 can be linked to or grouped with other contact data such as the contact data for employees, owners, related companies, companies that own or are owned by Alfonzo Plumbing. Such a grouping can enhance the discoverability of provider data 204 within relationship data-store 124 by enlarging the connectivity data.

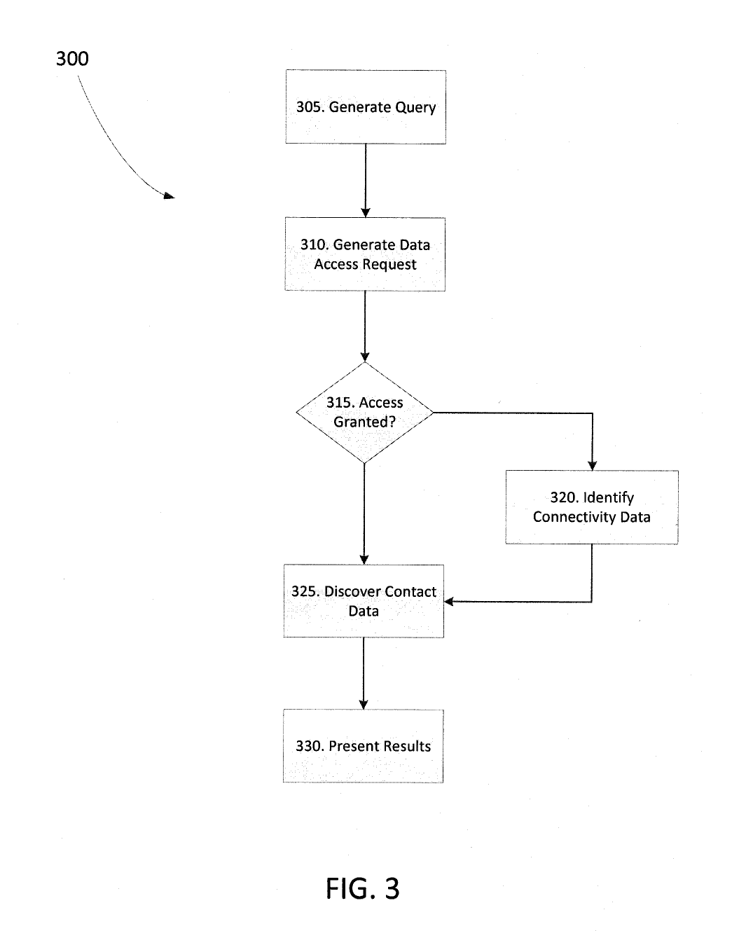

Referring now to FIG. 3, a method of connectivity data processing and searching is indicated generally at 300. In order to assist in the explanation of the method, it'll be assumed that method 300 is operated using system 100 as shown in FIG.1. Additionally, the following discussion of method 300 leads to further understanding of system 100. However, it is to be understood that system 100, and method 300 can be varied, and need not work exactly as discussed herein in conjunction with each other, and that such variations are within scope.

Beginning first at 305, a discovery query is generated. Typically, the query will be provided by a seeker contact, seeking to discover a particular provider contact. For example, the seeker might be a person seeking to find a service provider such as a plumber or a lawyer. The seeker may have been directed to the discovery services provided by server 112 through a variety of means such as the result of a web search, directory sites, advertisements and third party links. For example, a news site or a directory site could provide this discovery service as part of the overall services offered by those sites operated at third party servers 116.

The query provided can include information regarding search preferences such as service type desired, location and other attributes and criteria to help with the search. The query can be generated through an application executing on client terminal 104 or through a web application provided by discovery server 112 or third party server 116 with access to services provided by discovery server 112. Continuing with the illustrative example embodiment, it is assumed that the discovery query is generated by a web based application at a client terminal 104. In variations, the query can be transmitted to server 112. It'll be assumed that the query is made by contact “Eva” and the query criteria is a “plumber”.

In a variation, a seeker might have already identified a service such as a web site operated by a provider contact, and now desires to query the relations of the service provider to determine if any of the relations are associated with the seeker. For example, a contact “Eva”, upon arriving at a web site operated by Alfonzo plumbing and maintained at one of the servers 116 or at server 112, can query the connectivity data for Alfonzo Plumbing to determine if data pertaining to anyone she is associated with, such as a friend, can be located within data-store 124 as an association of Alfonzo Plumbing.

Continuing with method 300, at 310 a request is generated to access seeker's data. The request can be generated at the server 116 the client terminal is connected to. Alternatively, the request can be generated at a client terminal seeker contact is operating in accordance with an application or web based application executing on the client terminal 104. The purpose of the request is to obtain permission to gather information to construct connectivity data for the requester. Accordingly, the request is to gather relation and association information for that seeker contact. The request can take the form of a request for one or more of access to local data, remote data, or data maintained by third party services and others that will now occur to a person of skill in the art. Continuing with the example embodiment, a data access request is generated and presented at a terminal 104. In variations, the request can be generated at discovery server 112 or at a third party server through which discovery server 112 is accessed. It'll be assumed that the request is for accessing “Eva”'s “friends” at Facebook.

Continuing with method 300, at 315 a determination is made whether the request for data access is granted. This determination can be made at the client terminal 104, a third party server 116 used for accessing the services of server 112, or at the discovery server 112. In variations, determination can be made by accessing third party APIs with the information provided such as username and password. In other variations, the determination is made on the bases of the information provided alone, such as a consent to access the client terminal 104 operated by the seeker. If the determination is that access is granted, method 300 advances to 320. If on the other hand access is denied, method 300 progresses to 325. In the present example embodiment it'll be assumed that access is granted, and the method moves to 320.

At 320, connectivity data for the seeker contact is identified and retrieved. Building seeker connectivity data aids with searching or otherwise processing data-store 124. To identify and build connectivity data for the seeker contact, seeker data is gathered from terminal 104-3 or other sources that contain data about the seeker contact. The seeker data gathered can include one or more of seeker's name, email, and other identifying characteristics.

Connectivity data for the seeker typically also includes first-level associations representing relationships a seeker has such as “colleague”, “friend”, “neighbor” and “reviewer” as well as metadata related to those associations as indicators of the relationship's strength or importance or other indicators of relationship quality such as an endorsement, closest friend, quantity of services provided and others that will now occur to a person of skill in the art. Connectivity data for the seeker typically further includes first-level relation data indicative of contacts which have a direct relationship or relationships with the seeker. For example, if the connectivity data includes a first-level relation data that is associated with a seeker data through a “friend” association, that connectivity data would be indicative that the first-level relation represented by that first-level relation data is a friend of the seeker represented by that seeker data.

It will now be apparent to a person of skill in the art that additional level associations and relations can be added to a seeker's connectivity data as required. Indeed, connectivity data can comprise of any level of associations and relations, in a manner that forms lists, trees, graphs or networks depending on the complexity of the connectivity data. The manner in which a seeker's connectivity data is stored is not limited and can include databases, linked lists and other data structures that would allow the storage of lists, trees graphs or networks.

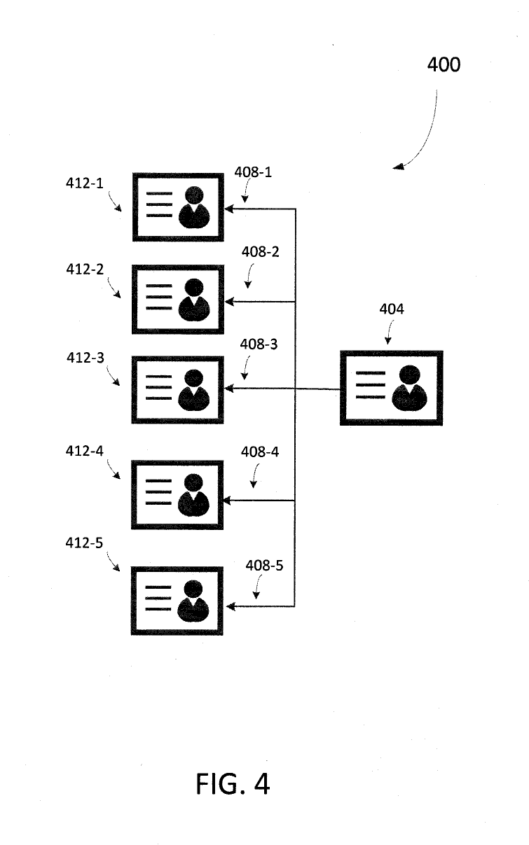

Referring to FIG. 4, an example connectivity data for a seeker is shown at 400 in accordance with an embodiment. Connectivity data 400 includes seeker contact-data as indicated at 404. Seeker contact-data can be data which is representative of the seeker contact and can include, for example, email, and other identifying information related to that contact. Additional information can also be included such as additional contact information, location and others. Alternatively, less information can be included, such that the seeker data 404 includes, for example, just an email, or hash of an email. Continuing with the example embodiment, it'll be assumed that in this embodiment, contact data 404 is for “Eva”, and includes an email, an address and a telephone number. It is to be understood that example connectivity data 400 is shown merely as an illustrative example and for the purposes of explaining various embodiments. Connectivity data with different content and organization will now occur to a person of skill in the art and is within scope.

Continuing with FIG. 4, in accordance with the indicated seeker connectivity data 400, seeker data 404 has first-level associations 408 (first level associations 408-1, 408-2, 408-3, 408-4 and 408-5). Collectively, first level relations data 408-1, 408-2, 408-3, 408-4 and 408-5 are referred to as first level associations 408, and generically as first level associations 408. This nomenclature is used elsewhere herein. First-level associations 408 are for associating provider data 404 with first-level relations data 412 (first level relations data 412-1, 412-2, 412-3, 412-4 and 412-5). Collectively, first level relations data 412-1, 412-2, 412-3, 412-4 and 412-5 are referred to as first level relations data 412, and generically as first level relations data 412. This nomenclature is used elsewhere herein. First-level associations 408 can be indicative of different types of relationships that a seeker contact can have with others as well as the strength or importance of that relationship such as ratings, endorsements, and amount of interaction or location proximity. First-level relations data 412 can be contact-data indicative of relations with whom provider contact has established direct relationships. Continuing with the example embodiment, it'll be assumed that all associations 408 are of type “customer”, indicating that relations 412 are clients or customers of “Eva”. Moreover, it'll be assumed that relations contact-data 412-1 is named “Emma”.

Connectivity data 400 can also include first level metadata (not shown) indicative of the strength or importance of an association 408 based on such metadata as ratings, endorsements, and quantity of services provided, for example.

It will now be apparent to a person of skill in the art that, as described above in the context of a provider contact, two or more levels of relationship data can be used in building the connectivity data for a seeker contact. These and other variations are within scope. Moreover, it will now be understood that example connectivity data 400 shown in FIG. 4 is an illustrative example and that connectivity data 400 can take on greater complexity. For example, a provider data 404 can have different associations 408 with different first-level relations data 412, such that, seeker data 404 can have one type of association 408, such as “friend”, with some first-level relations data 412, while other first-level relations data 412 can have, with seeker data 404, different types of first-level association 408, such as “colleague” or different relationship quality identifiers or both. In other variations, seeker data 404 can have multiple first-level associations 408 with a first-level relation data 412 indicating that the provider contact represented by seeker data 404 has, for example, both a friend and a colleague relationship with a relation contact indicated by a first-level relation data 412. A person of skill, in the art will now understand that similar variations are also possible for second-level associations and relationships, and are within scope.

Connectivity data 400 can be obtained in numerous ways. For example, in one embodiment, a seeker can provide its contact information, representing first-level relations along with relationships that define the first level association with each of the provided contact information. The provided contact information can be obtained from a contacts database maintained at a terminal 104 or a server 116. The provided contacts can also be obtained from a web site operated by the seeker. For example, continuing with the present example embodiment, “Eva” can obtain contact information manually and store it in a contacts database. “Eva” can also maintain a web site at a third party server 116. Relations of “Eva” can be given the ability to enter, at the web site, their contact information, as well as additional information such as pictures comments and others that will now occur to a person of skill in the art. All of this information can be maintained as part of the web site, or may be transferred to a data-store 120 or a contacts database for storage. Alternatively, parts or all of the information collected from the clients can be provided as part of the web pages of the web site and mined for use.

Connectivity data can also be obtained from one or more third party services, such as Facebook™, Google™, Twitter™ or LinkedIn™, and other networked data sources, including call center servers, directories, commerce servers, web services and other information service providers and aggregators. In one variation, discovery server 112 obtains data from third party services by functioning as an aggregator, accessing the respective service's access points or APIs, having obtained appropriate permissions if necessary. Alternatively, discovery server 112 can obtain data from third party services and other networked sources by accessing third party aggregator services that aggregate information from the third party services as well as from other networked information sources. Discovery server 112 is typically linked to the third party access points or aggregators, or a combination thereof, through network 108. Other methods of connecting to third party services and aggregators are contemplated such as through proxies and gateways are considered within scope.

Seeker's contacts can be obtained from a third party data-store, such as Google™ Contacts maintained for the seeker contact “Eva”. “Eva” can also maintain membership with third party services such as social networking sites. Accordingly, at least some of the provided contacts can be obtained from these services based on connections that “Eva” has made at those third party services. For example, “Eva” can maintain a membership at the social networking site Facebook™, maintained by at least one of the third party servers 116 of FIG. 1, and the provided contacts can be those that “friended” or otherwise connected with “Eva”'s Facebook™ membership. In other variations, “Eva”'s contacts can be obtained through web search results provided by web search providers such as Google™ and Bing™. Searches can be conducted to identify friends and other relations that have posted comments, pictures and other information regarding “Eva” on their own sites, on sites maintained by others, blogs, social networking sites and others that will now occur to a person of skill in the art. Connectivity data for the seeker can be compiled by client terminal 104, server 112 or a third party server 112 used to access services provided by discovery server 112.

Continuing with the present example embodiment, it'll be assumed that “Eva”'s contacts are extracted from Facebook™ by accessing the Facebook™ APIs based on the access granted by “Eva” at 315. Connectivity data 400 is then constructed on the basis of this data, and includes at 412-1 first-level relation data for contact “Emma”.

Referring back to FIG. 3 and continuing with method 300, at 325 contact data is discovered. Searching or otherwise processing the data-store 124 on the basis of the seeker connectivity data can allow the discovery of a provider data maintained in data-store 124 that matches the query criteria, thus identifying contact data that meets the query criteria such as a plumber or a lawyer. Alternatively, or in addition, searching or otherwise processing data-store 124 on the bases of the seeker connectivity data can identify relations that the two connectivity data share, the associations between the seeker contact data and the provider data, and metadata related to those associations. Moreover, since the search is based on contacts that have direct or indirect relationship with the seeker, the generated results are of higher reliability and validity than the results of a general search such as a web search.

To perform the discovery, in one embodiment, data-store 124 containing provider connectivity data is searched to identify a provider contact that matches the query criteria. Accordingly, the relations data in the data-store can be searched to identify matches with either the relations data or the seeker data of the seeker connectivity data. A match can then be traced to a provided data to identify the queried provider contacts. Alternatively, data-store 124 can be searched to identify a relationship between the seeker and the provider. In this case, the provider data is provided and the relations data included in that specific provider's connectivity data are searched for matches with the seeker or the seeker's relations.

It'll now be apparent to those of skill in the art that various method for searching lists, graphs and networks can be used to effect the search and are within scope. For example, seeker data and each relation data contained within seeker connectivity data can be used as the basis of searching provider connectivity data maintained by data-store 124. In those cases where no access was granted to access relations data of the seeker, the seeker data alone can be used to perform the search and discovery.

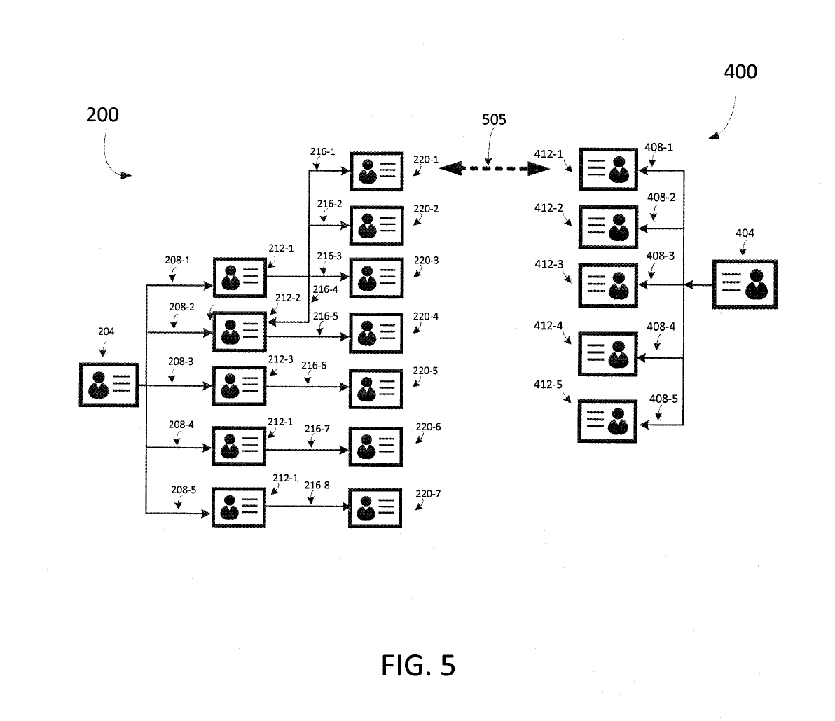

Once a relation is identified within data-store 124 that matches a contact data contained within seeker connectivity data, the provider data associated with that relation is identified. The identified provider data is then examined to determine whether it meets the search criteria. The search can be performed based on one or more data maintained as part of each relation and seeker data such as an email, name, phone number and others. Continuing with the example embodiment and referring to FIG. 5, the results of performing a search of connectivity data 200 using connectivity data 400. The search results indicate that the second-level relation data 220-1 is a match to first level relation data 412-1 based on the name “Emma”, as indicated at the dotted line 505. Accordingly, the provider data related to relations data 420-1 is retrieved, which in this example is the provider data 204 for Alfonzo Plumbing. Next, provider data for Alfonzo Plumbing is checked to determine whether the query criteria is satisfied. In this case the query criteria is “plumber”, which is satisfied by the service type data for Alfonzo plumbing. In variations, the search can be performed in a different order. For example, first all provider data that satisfy the search criteria can be identified and only the connectivity data associate with those provider data searched. These and other variations in search methodology are within scope.

In further variations, the provider connectivity data may not be stored in data-store 124. Instead, data-store 124 can contain only the provider data. The connectivity data for the provider, such as connectivity data 200, can then be built on demand prior to each search. In other variations, the search can be performed at the server 112 after the seeker connectivity data is received at server 112. Alternatively, the search can be performed at a terminal 104, and the contents of data-store 124 sent to client terminal 104 to enable the search. In other variations, client terminal 104 can maintain a mirror of the data store 124. In further variations, some of all of the data stored may be hashed data to prevent the contents of the data from being accessible. However, as it will be understood, hashed data can nevertheless still be utilized for search purposes.

In additional variations, criteria other than exact matching of one or more fields can be used to identify matching relations. For example, one criteria can be neighbors and relations would be considered to be matched if the address data for those relations indicate that the relations live or work within close proximity, such as within x kilometers, in the same building, in the same city and other geographic relations so that they can be considered geographically related, such as in the case of neighbors. Alternatively, inexact matches can be used to augment or select from exact matches. For example, if there are multiple matches, those with the closest association with a seeker can be prioritized over those that are farther. These and other variations are within scope.

Referring back to FIG. 3, and continuing with method 300, at 330, results are presented. Results can be presented in a variety of manners. For example, they can be a simple list of provider contact data that were discovered through the search process. Alternatively, the list can be prioritized on the bases of relationship closeness. For example, those providers that are connected to the seeker through a first-level relation can be prioritized over those that are connected through a second-level relation. Further, the results can be prioritized based on metadata such as relationship strength indicators including strength of endorsement, the volume of service (providers providing larger volume of service being prioritized for example). Other alternatives of presenting results will now occur to those of skill in the art and are within scope.

In other embodiments, the association chain between the seeker and the provider or providers discovered can also be indicated. For example, in the example embodiment, Eva might be informed that Emily received direct services from Alfonzo plumbing, and Emily knows Emma, who is also Eva's friend. In variations, the seeker can be given the option to contact one or more of the intermediate relations connecting her to the provider to obtain further information on the service, and to validate the relations, for example.

In other variations, the provider data may actually represent certain goods and tangible and intangible property. In these variations, the relations could represent those contacts who have actually purchased, rented or otherwise dealt with those specific goods, such as purchasers of certain brands of cars or sizes of TVs. Accordingly, queries would be to identify goods or other property that have been purchased, rented or otherwise rented by relations of a seeker.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method for a computing device, of contact discovery comprising:
building a provider connectivity data;
receiving a query for a contact;
building a seeker connectivity data; and
searching said provider connectivity data based on said seeker connectivity data.

2. The method of claim 1 wherein said provider connectivity data includes a first level provider association data and a first level provider relations data.

3. The method of claim 2 wherein said seeker connectivity data includes a first level seeker association data and a first level seeker relations data.

4. The method of claim 1 wherein said provider connectivity data is obtained from at least one of a contacts database and a third party service provider.

5. The method of claim 4 wherein said third party service provider is at least one of a social networking service, a web hosting service, a directory service and an aggregator service.

6. The method of claim 3 wherein said method further comprises:
identifying, based on said searching, a result including at least one of a provider contact data and an association chain.

7. The method of claim 6 wherein said provider connectivity data and said seeker connectivity data include metadata, the method further comprising:
Prioritizing said result based on metadata.

8. The method of claim 7 wherein said metadata includes at least one of relationship strength indicator, endorsement, service volume and reviews.

9. The method of claim 6 wherein said identifying said result is based on matching said first level provider relation data with said first level seeker relation data.

10. The method of claim 9 wherein said matching is based on a geographic relationship.

11. The method of claim 10 wherein said geographic relationship is based on proximity.

12. The method of claim 6 wherein said method further comprises:
identifying, based on said searching, a relation data representing a relation; and
generating an incentive based on said identified relation data.

13. The method of claim 1 further comprising:
obtaining authorization for building said provider connectivity data.

14. The method of claim 13 wherein said provider connectivity data includes a first and a second level provider relation data and said authorization is obtained based on said first level provider relation data.

15. The method of claim 1 wherein said building of said provider connectivity data includes maintaining said provider connectivity data in a data-store.

16. The method of claim 6 wherein said identifying is based on a query criterion.

17. The method of claim 16 wherein said query criterion is matching one of a provider contact data or a relation contact data.

18. A system of contact discovery comprising:
a computing device configured for:
building a provider connectivity data;
receiving a query for a contact;
building a seeker connectivity data; and
searching said provider connectivity data based on said seeker connectivity data.

19. The system of claim 18 wherein said computing device is a server.

20. The system of claim 19 wherein said computing device is further configured to obtain said provider connectivity data from at least one of a contacts database and a third party service provider.
